(19) United States
(12) Patent Application Publication
(10) Pub. No.: US 2012/0080911 A1
(43) Pub. Date: Apr. 5, 2012

(54) FLUID DISTRIBUTION FEATURES FOR CLIMATE CONTROLLED SEATING ASSEMBLIES

(75) Inventors: Michael Brykalski, Monrovia, CA (US); Raymund Manuel, Los Angeles, CA (US); Scott Wolas, Newbury Park, CA (US)

(73) Assignee: Amerigon Incorporated, Northville, MI (US)

(21) Appl. No.: 13/220,447

(22) Filed: Aug. 29, 2011

Related U.S. Application Data
(60) Provisional application No. 61/377,892, filed on Aug. 27, 2010.

(51) Int. Cl. A47C 7/74; B60N 2/56

(52) U.S. Cl. 297/180.15

(57) ABSTRACT

According to some embodiments, a climate controlled seat assembly (e.g., a vehicle seat, a bed assembly, etc.) comprises a cushion or other support member positioned along a seat bottom portion or a seat back portion of the seat assembly, wherein the cushion includes a first surface configured to contact an occupant and a second surface generally opposite of the first surface. The cushion includes a cushion depth that generally extends between the first surface and the second surface of the cushion. The seat assembly further comprises at least one fluid passage positioned and routed at least partially through the cushion depth, wherein the fluid passage generally extends to the second surface of the cushion. Further, the seat assembly comprises at least one fluid module configured to selectively thermally and/or environmentally condition air and to transfer said thermally conditioned air through the fluid passage.

### CROSS REFERENCE TO RELATED APPLICATIONS

This application claims the priority benefit under 35 U.S.C. §119(e) of U.S. Provisional Patent Application No. 61/377,892, filed Aug. 27, 2010, the entirety of which is hereby incorporated by reference herein.

### BACKGROUND

1. Field of the Inventions

This application generally relates to climate controlled seating assemblies, and more specifically, to channels, passages and other features in foam pads or other support structures of such seating assemblies.

2. Description of the Related Art

Temperature modified air for environmental control of an automobile, other vehicles or any other living or working space is typically provided to relatively extensive areas, such as an entire automobile interior, selected offices or suites of rooms within a building (e.g., houses, hospitals, office buildings, etc.) and the like. In the case of enclosed areas, such as automobiles, trains, airplanes, other vehicles, homes, offices, hospitals, other medical facilities, libraries and the like, the interior space is typically heated and/or cooled as a unit. There are many situations, however, in which more selective or restrictive air temperature modification is desirable. For example, it is often desirable to provide an individualized climate control for a seat assembly so that substantially instantaneous heating or cooling can be achieved. For example, a vehicle seat, chair or other seat assembly situated in a relatively cold or hot environment can be uncomfortable to the occupant. Furthermore, even in conjunction with other heating or cooling methods, it may be desirable to quickly thermally condition the seat to enhance the occupant's comfort, especially where other climate control units (e.g., automobile's temperature control system, home's central heater, etc.) take a relatively long time to reach a desired thermal conditioning level. Therefore, a need exists to provide thermally-conditioned air through channels of a seating assembly.

### SUMMARY

According to some embodiments, a climate controlled seat assembly (e.g., a vehicle seat, a bed assembly, etc.) comprises a cushion or other support member positioned along a seat bottom portion or a seat back portion of the seat assembly, wherein the cushion includes a first surface configured to contact an occupant and a second surface generally opposite of the first surface. The cushion includes a cushion depth that generally extends between the first surface and the second surface of the cushion. The seat assembly further comprises at least one fluid passage positioned and routed at least partially through the cushion depth, wherein the fluid passage generally extends to the second surface of the cushion. Further, the seat assembly comprises at least one fluid module having a fluid transfer device (e.g., blower or fan) and a thermal conditioning device (e.g., thermoelectric device, a convective heater, another heating or cooling device, a dehumidifying device and/or the like) configured to selectively thermally and/or environmentally condition air and to transfer said thermally conditioned air through the fluid passage, wherein the fluid module comprises an inlet and an outlet. In one embodiment, the outlet of the fluid module is in fluid communication with the fluid passage. In some embodiments, the seat assembly additionally comprises a fluid distribution region positioned along or near the first surface of the cushion, wherein the fluid distribution region (e.g., a spacer fabric, other spacer material, air permeable foam, other air permeable member or device, etc.) is configured to receive thermally and/or environmentally conditioned air from the main passage and to at least partially distribute such air along the first (e.g., top or front) surface of the cushion (or other support member, e.g., bed mattress). In some embodiments, the seat assembly also comprises one or more recirculation fluid passages configured to return at least a portion of the thermally and/or environmentally conditioned air discharged through the fluid distribution region toward the inlet of the fluid module. In one embodiment, the recirculation fluid passage places the fluid module in fluid communication with an area adjacent the first surface of the cushion.

According to some embodiments, the recirculation fluid passage extends at least partially through an interior portion of the cushion. In another embodiment, the recirculation fluid passage extends at least partially through an exterior portion of the cushion. In some embodiments, the seat assembly further comprises one or more vent regions situated or otherwise located between the first surface of the cushion and the recirculation passage, wherein such vent region is configured to enhance the receipt of recirculated air into the recirculation passage from along or near the first surface of the cushion. In some embodiments, the vent region comprises a recess along the first surface of the cushion. In some embodiments, the vent region comprises a funnel or conical shape. In yet other embodiments, the vent region comprises a generally cylindrical or irregular shape. In some embodiments, a seat assembly comprises one, two, three, four or more than four vent regions along a cushion or other support structure.

According to some embodiments, the recirculation passage originates in or near the fluid distribution region. In one embodiment, the vent region is in direct fluid communication with the fluid distribution region (e.g., spacer fabric or other material). In some arrangements, the recirculation passage is located generally below the fluid distribution region. In another embodiment, the seat assembly further includes one or more scrims, other air permeable or air impermeable layers or portion and/or the like between the recirculation passage and the fluid distribution region. In one embodiment, the seat assembly additionally comprises one or more covering air permeable and/or partially air permeable layers along the first surface and/or the second surface of the cushion. In one embodiment, the fluid distribution region comprises at least one spacer material (e.g., spacer fabric), honeycomb structure, air permeable foam and/or any other member or material configured to generally distribute fluids entering therein.

According to some embodiments, a climate controlled seat assembly comprises a cushion positioned in a seat bottom portion and/or a seat back portion of the seat assembly, wherein the cushion includes a first surface (e.g., top or front surface) configured to contact an occupant and a second surface (e.g., bottom or rear surface) generally opposite of the first surface; The seat assembly further comprises at least one fluid conduit positioned at least partially within an interior of the cushion and a fluid module comprising a fluid transfer device and a thermal conditioning device configured to selectively heat, cool or ventilate air, said fluid module. In some embodiments, the fluid module is positioned within a bolster region of the cushion. In some embodiments, an outlet of the fluid module is in fluid communication with the fluid conduit. In some embodiments, the seat assembly additionally comprises at least one fluid distribution member positioned along the first surface of the cushion, wherein the fluid distribution member is configured to receive air from the fluid conduit and to generally distribute such air along the first surface of the cushion. In one embodiment, the seat assembly further comprises one or more recirculation passages or conduits configured to return at least a portion of the air that is within or that has exited the fluid distribution member toward an inlet of the fluid module. In one embodiment, the recirculation passage places the fluid module in fluid communication with an area adjacent the first surface of the cushion.

According to some embodiments, the recirculation passage is positioned in the bolster region of the cushion. In one embodiment, the recirculation passage originates at, in or near the fluid distribution member (e.g., spacer material, spacer fabric, etc.). In some embodiments, the recirculation passage is in direct fluid communication with the fluid distribution member.

According to some embodiments, a climate controlled seat (e.g., a vehicle seat, a bed assembly, a wheelchair, etc.) comprises a cushion or other support member (e.g., positioned along a seat bottom portion or a seat back portion of the seat assembly), wherein the cushion or other support member includes a top surface configured to contact at least one occupant and a bottom surface generally opposite of the first surface. The seat further comprises at least one interior passage extending at least partially within an interior of the cushion, wherein the interior passage generally terminates at or near at least one fluid channel located along the top surface of the cushion. In some embodiments, the interior passage places the fluid channel in fluid communication with a fluid module in order to selectively transfer air from or to the fluid module to or from the fluid channel. In some embodiments, the seat assembly further includes a recess formed along the top surface of the cushion, wherein the recess at least partially surrounds the fluid channel along the top surface of the cushion. In some embodiments, the seat assembly comprises one or more cover members (e.g., one or more scrims) positioned at least partially within the recess and above the fluid channel(s), wherein the cover member and the fluid channel define at least one fluid passageway therebetween. In some embodiments, the seat assembly additionally comprises a plurality of fluid openings located along or near the cover member, wherein air exits the fluid passageway through the fluid openings. In one embodiment, the interior passage is generally offset relative to a horizontal centerline of the cushion. In some embodiments, the fluid channel is configured to generally hydraulically balance airflow exiting through the plurality of fluid openings.

According to some embodiments, a width and/or a depth of the fluid channel varies along a length of the at least one fluid channel. In some embodiments, the depth and/or width of a fluid channel (as measured from the top surface of a cushion or other support member in which the channel is formed) can vary by about 5%, 10%, 15%, 20%, 25%, 30%, 35%, 40%, 45%, 50%, 55%, 60%, 65%, 70%, 75%, 80%, 85%, 90%, 95%, 100%, more than about 100%, less than about 5%, percentages in between the foregoing values, etc. from one location of a channel to another (e.g., regardless of whether it is the same of a different branch of leg of the channel). In some embodiments, a bottom surface of at least one fluid channel is sloped relative to the top surface of cushion along at least a portion of a length of the at least one fluid channel. According to some embodiments, at least two of the fluid openings vary in size. According to some embodiments, the cross-sectional area of one opening 380 can be about 10%, 20%, 30%, 40%, 50%, 100%, 200%, 300%, 400%, 500%, 600%, 700%, 800%, 900%, 1000%, 2000%, 3000% smaller or larger, less than about 10% larger or smaller, more than about 3000% smaller or larger, percentages between the foregoing values, etc. than the cross-sectional area of another opening in the same channel.

According to some embodiments, a method of improving the efficiency of a fluid module included in a climate controlled seating assembly (e.g., vehicle seat, bed assembly, etc.) comprises recirculating at least a portion of air that has been environmentally conditioned (e.g., cooled, heated, dehumidified) by one or more fluid modules of the seating assembly back to an inlet of at least one fluid module, thereby lowering a ΔT of the fluid module receiving the recirculated air or other fluid. In some embodiments, recirculated air first enters a recess or other receiving portion along an outer portion of the seat assembly before being transferred to an inlet of a fluid module. In some embodiments, the region in which recirculated air enters the seat assembly (e.g., cushion, mattress, other support member, etc.) is generally a low pressure, low contact area. In some embodiments, the method comprises drawing recirculated air into an interior of the seat assembly via a bolster or other side portion of the cushion or other support member. In some embodiments, the method comprises drawing cooled and/or heated air from a fluid distribution region or member along an upper or front portion of the seat assembly, wherein said fluid distribution region or member is in fluid communication with an outlet of at least one fluid module of the seat assembly.

According to some embodiments, a method of recirculating environmentally (e.g., heated, cooled, dehumidified, etc.) fluid exiting a top surface of seating assembly (e.g., vehicle seat, bed assembly, etc.) comprises transferring at least a portion of air that has been environmentally conditioned (e.g., cooled, heated, dehumidified) by one or more fluid modules of the seating assembly back to an inlet of at least one fluid module. In some embodiments, recirculated air first enters a recess or other receiving portion along an outer portion of the seat assembly before being transferred to an inlet of a fluid module. In some embodiments, the region in which recirculated air enters the seat assembly (e.g., cushion, mattress, other support member, etc.) is generally a low pressure, low contact area. In some embodiments, the method comprises drawing cooled and/or heated air from a fluid distribution region or member along an upper or front portion of the seat assembly, wherein said fluid distribution region or member is in fluid communication with an outlet of at least one fluid module of the seat assembly.

According to some embodiments, a climate controlled seat assembly comprises a cushion positioned along a seat bottom portion or a seat back portion, wherein the cushion includes a first surface configured to contact an occupant and a second surface generally opposite of the first surface. The seat assembly comprises a main passage positioned at least partially within an interior of the cushion, wherein the main passage generally extends to the second surface of the cushion. The seat assembly further includes a fluid module having a fluid transfer device (e.g., fan, blower, etc.), a thermal conditioning device (e.g., thermoelectric device, convective heater, etc.) and/or other components (e.g., sensors, control units, housing, etc.) configured to selectively heat or cool air, wherein the fluid module comprises an inlet and an outlet. According to some embodiments, the outlet of the fluid module is in fluid communication with the main passage. The climate controlled seat assembly additionally comprises a fluid distribution region positioned along the first surface of the cushion, the fluid distribution region configured to receive thermally-conditioned air from the main passage and to generally distribute the thermally-conditioned air along the first surface of the cushion. The fluid distribution region can include a spacer fabric or other spacer material. In some embodiments, the seat assembly further includes one or more recirculation passages configured to return at least a portion of the thermally-conditioned air that is within or that has exited the fluid distribution region toward the inlet of the fluid module. In one embodiment, the recirculation passage extends at least partially through the cushion.

According to several embodiments, the seat assembly further comprises at least one vent region situated between the first surface of the cushion and the recirculation passage, wherein the vent region is configured to enhance the drawing of recirculated air into the recirculation passage. In one embodiment, the vent region comprises a recess along the first surface of the cushion. In some embodiments, the vent region comprises a funnel or cylindrical shape. In several arrangements, the recirculation passage originates in or near the fluid distribution region. In one embodiment, the recirculation passage is located below the fluid distribution region. In one embodiment, the seat assembly further comprises a scrim located between the recirculation passage and the fluid distribution region. In some arrangements, the seat assembly further comprises a covering layer along the second surface of the cushion, wherein the covering layer is generally air permeable.

According to some embodiments, a climate controlled seat assembly comprises a cushion positioned along a seat bottom portion or a seat back portion of the seat assembly, wherein the cushion having a first surface configured to contact an occupant and a second surface generally opposite of the first surface. The seat assembly additionally includes a main passage positioned at least partially within an interior of the cushion, a fluid module (e.g., comprising, among other things, a fluid transfer device and a thermal conditioning device configured to selectively heat or cool air, etc.). In some embodiments, the fluid module comprises an inlet and an outlet. In some embodiments, the fluid module is positioned within a bolster region of the cushion. In other arrangements, the outlet of the fluid module is in fluid communication with the main passage. The seat assembly further includes a fluid distribution region positioned along the first surface of the cushion, wherein the fluid distribution region is configured to receive thermally-conditioned air from the main passage and to generally distribute said thermally-conditioned air along the first surface of the cushion. In some embodiments, the seat assembly additionally comprises one or more recirculation passages configured to return at least a portion of the thermally-conditioned air that is within or that has exited the fluid distribution region toward the inlet of the fluid module. According to some embodiments, the recirculation passage is positioned in the bolster region of the cushion. In other arrangements, the recirculation passage originates in the fluid distribution region.

According to some embodiments, a climate controlled seat includes a cushion positioned along a seat bottom portion or a seat back portion of the seat assembly, wherein the cushion has a first surface configured to contact an occupant and a second surface generally opposite of the first surface. The seat additionally includes a main passage positioned at least partially within an interior of the cushion, wherein the main passage is configured to be placed in fluid communication with a fluid module in order to selectively provide thermally-conditioned air to through said main passage. The seat further comprises a recess formed along the first surface of the cushion, at least one channel formed along the first surface of the cushion within the recess and a scrim positioned within the recess and above the channel. In some embodiments, the scrim and the channel define at least one channel passage therebetween. The seat additionally includes a plurality of fluid openings located along the scrim, wherein air exits the channel passage through the plurality of fluid openings. In some embodiments, the main passage is offset relative to a horizontal centerline of the cushion. In several embodiments, the main passage is nonsymmetrical relative to the at least one channel. In one embodiment, the climate controlled seat is configured to generally balance airflow and/or thermal conditioning through the plurality of fluid openings.

According to some embodiments, a width and/or depth of the channel varies along at least part of its length. In some embodiments, a bottom surface of the channel is sloped along at least a portion of the channel length. In one embodiment, at least two of the fluid openings vary in size.

### BRIEF DESCRIPTION OF THE DRAWINGS

These and other features, aspects and advantages of the present application are described with reference to drawings of certain embodiments, which are intended to illustrate, but not to limit, the present inventions. It is to be understood that these drawings are for the purpose of illustrating concepts of the present inventions and may not be to scale.

FIG. 1 schematically illustrates a climate controlled seat assembly having a seat back portion and a seat bottom portion according to one embodiment;

FIG. 2 illustrates a cross-sectional view of one embodiment of a climate control seat configured to recirculate a portion of the air being delivered to the top surface of the bottom portion;

FIG. 3 illustrates a partial cross-sectional view of a seat assembly configured to recirculate a portion of climate controlled air from the top surface of the bottom portion according to one embodiment;

FIG. 4 illustrates a cross-sectional view of a seat bottom or seat back portion of a climate controlled seat assembly configured to permit air to enter the inlet of a fluid delivery module from the top or front surface of the portion according to one embodiment;

FIG. 5 illustrates a cross-sectional view of a seat bottom or seat back portion of a climate controlled seat assembly configured to permit air to enter the inlet of a fluid delivery module from the top or front surface of the portion according to another embodiment;

FIG. 6A illustrates a cross sectional view of a cushion of a seat bottom portion of a seat assembly being configured to selectively deliver air from the top to the bottom of the cushion, toward the inlet of a fluid module according to one embodiment;

FIG. 6B illustrates a top view of the cushion of FIG. 6A;

FIG. 7 illustrates a perspective view of a climate controlled assembly configured to receive a fluid module in one or more of its bolster areas according to one embodiment;

FIG. 8 illustrates a cross-sectional side view of a bolster portion of a seat assembly comprising a fluid module mounted therein according to one embodiment;

FIG. 9A illustrates a side view of a bolster portion of a seat assembly configured to receive a fluid module according to one embodiment;

FIG. 9B illustrates a side view of a bolster portion of a seat assembly configured to receive a fluid module according to another embodiment;

FIG. 10A illustrates a top view a cushion comprising fluid channels formed therein and configured for use in a seat bottom or seat back portion of a climate controlled seating assembly according to one embodiment;

FIG. 10B illustrates the cushion of FIG. 10A comprising a scrim attached thereto according to one embodiment;

FIG. 11A illustrates a top perspective view of one embodiments of a cushion having fluid channels formed thereon with an offset or asymmetrical inlet passage;

FIGS. 11B and 11C illustrate bottom perspective and top views, respectively, of the cushion of FIG. 11A;

FIG. 12 illustrates a top view of a cushion having fluid channels formed therein and a scrim according to one embodiment; and

FIGS. 13A and 13B illustrate cross-sectional views taken through the cushion of FIG. 12.

### DETAILED DESCRIPTION OF THE PREFERRED EMBODIMENTS

A variety of examples described below illustrate various configurations that may be employed to achieve desired improvements. The particular embodiments and examples provided herein are only illustrative and are not intended in any way to restrict the general inventions presented and the various aspects and features of these inventions. In addition, it should be understood that the terms cooling side, heating side, main side, waste side, cooler side and hotter side and the like do not indicate any particular temperature, but are relative terms. For example, the “hot,” “heating” or “hotter” side of a thermoelectric device or array may be at ambient temperature, with the “cold,” “cooling” or “cooler” side at a cooler temperature than ambient. Conversely, the “cold,” “cooling” or “cooler” side may be at ambient with the “hot,” “heating” or “hotter” side at a higher temperature than ambient. Thus, the terms are relative to each other to indicate that one side of the thermoelectric device is at a higher or lower temperature than the counter or opposing side. Moreover, as is known in the art, when the electrical current in a thermoelectric device is reversed, heat can be transferred to the “cold” side of the device, while heat is drawn from the “hot” side of the device. In addition, fluid flow is referenced in the discussion below as having directions. When such references are made, they generally refer to the direction as depicted in the two dimensional figures. The terminology indicating “away” from or “along” or any other fluid flow direction described in the application is meant to be an illustrative generalization of the direction of flow as considered from the perspective of two dimensional figures.

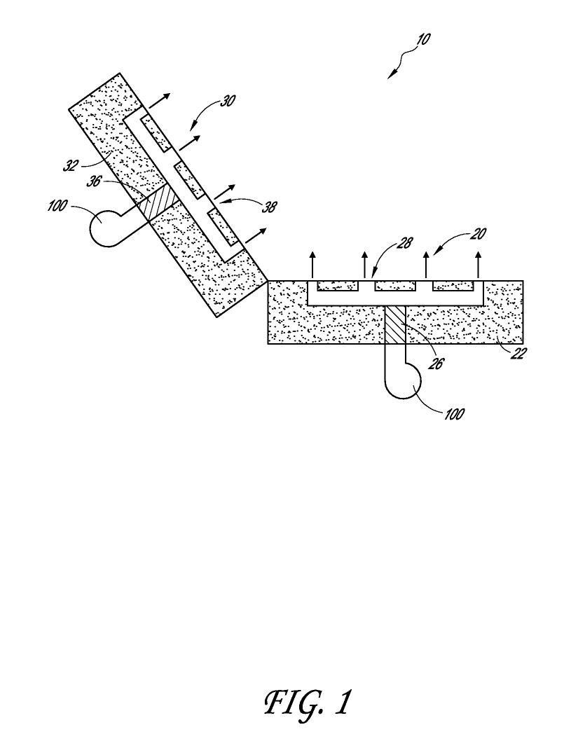

FIG. 1 schematically illustrates one embodiment of a climate controlled vehicle seat 10. The depicted seating assembly 10 includes a seat bottom portion 20 and a seat back portion 30. As shown, each of the seat bottom and seat back portions 20, 30 can include a fluid distribution system 28, 38 that is configured to receive environmentally-conditioned (e.g., heated, cooled, dehumidified, etc.) and/or ambient air or other fluid being delivered by a corresponding fluid module 100. However, in any of the embodiments disclosed herein or equivalents thereof, only the seat back or only the seat bottom portion of a seating assembly is configured to receive climate controlled and/or ambient air Likewise, in seat assemblies, such as, for example, beds, sofas and the like, that may not have separate and distinct portions (e.g., seat back and seat bottom portion), only certain areas targeted for environmental conditioning may be configured to receive air or other fluids. Accordingly, the various concepts and features disclosed herein can be applied to any seating assembly, including, without limitation, vehicle seats, beds, sofas, wheelchairs, other types of chairs and the like.

As used herein, the term “fluid module” is a broad term used in its ordinary sense and includes embodiments comprising one or more of the following: a fan or other fluid transfer device, a device configured to heat or cool a fluid and/or the like. The terms “fluid module” and “thermal module” are used interchangeably herein. In some embodiments, a fluid module 100 comprises a fluid transfer device (e.g., fan, blower, etc.), a thermoelectric device or TED (e.g., or other device configured to selectively heat or cool air, via convective heat transfer or otherwise), heat transfer members (e.g., fins) positioned along one or both sides of the TED or other temperature conditioning device, controller, sensors (e.g., temperature, humidity, condensation, etc), timers and/or the like. For example, a fluid module 100 can include a fan, blower or other fluid transfer device that is configured to transfer a certain volume of air through, past or near a main side heat exchanger, while simultaneously transferring another volume of air past a waste side heat exchanger. Air passing through the main air heat exchanger can be selectively heated or cooled (e.g., via heat transfer to or from the TED) before being delivered toward an outlet.

With continued reference to the schematic cross-sectional view of FIG. 1, environmentally-conditioned air exiting the main side outlet of a fluid module 100 can be directed to a corresponding internal passage 26, 36 of the seat bottom or seat back portion 20, 30 of the seating assembly 10. From such a passage 26, 36, air or other fluid can enter into and be distributed within one or more downstream fluid distribution members 28, 38 before exiting the seat assembly 10 toward a seated occupant. Although not shown in the schematic of FIG. 1, air exiting a waste side outlet of the fluid module 100 can be directed away from the seat assembly 10, as desired or required.

According to some embodiments, as illustrated in FIG. 1, one or more fluid modules 100 are configured to selectively deliver ambient and/or thermally-conditioned air to both the seat bottom 20 and the seat back portion 30 of a climate controlled seating assembly 10. Alternatively, however, a climate controlled seat assembly 10 can be configured to receive air or other fluid in only the seat bottom portion or the seat back portion of the assembly 10, in accordance with a desired environmental conditioning scheme or effect.

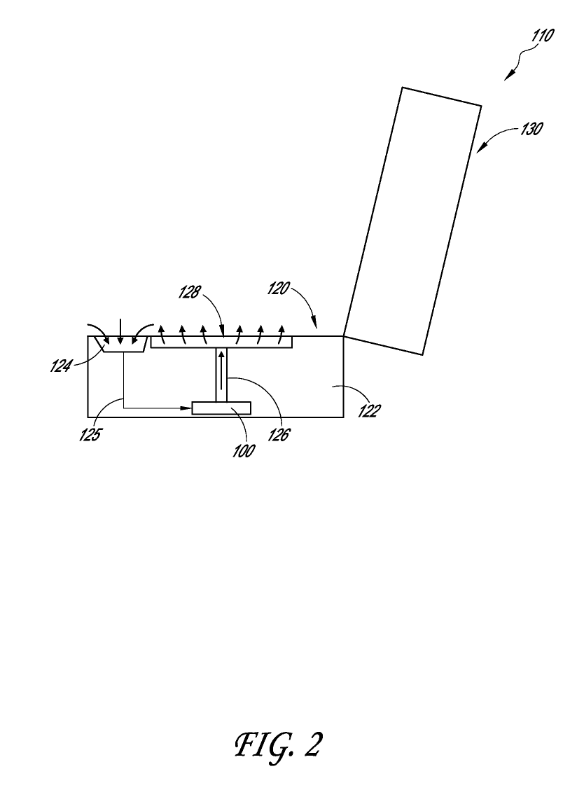

In some embodiments, at least a portion of the air passing through the inlet of a fluid module originates from or near the top or outer surface of a climate controlled seat assembly (e.g., a vehicle seat, a bed, etc.). For example, as illustrated in FIG. 2, a fluid module 100 associated with the seat bottom portion 120 of a seat assembly 110 can receive some or all of its inlet air from a recirculation line or conduit 125 adapted to be in fluid communication with one or more spaces or regions along the upper surface of the seat bottom portion 120. As shown, the fluid module 100 can be positioned, completely or at least partially, within an interior portion of the seat bottom 120 and/or seat back portion of the assembly (e.g., within the seat cushion, other support member of the seat assembly, etc.). In some arrangements, at least a portion of the air conveyed through the recirculation fluid conduit or line 125 toward the fluid module comprises environmentally or thermally conditioned (e.g., heated, cooled, dehumidified, etc.) air that exited the fluid distribution member 128 of the seat bottom portion 120. In the embodiment schematically illustrated in FIG. 2, the seat assembly 110 comprises only a single recirculation line or conduit 125. However, in other arrangements, a seat assembly can comprise additional recirculation lines or conduits (e.g., two, three, four, five, more than five, etc.), as desired or required.

As discussed in greater detail herein, directing at least a portion of air (e.g., thermally conditioned air that has passed through a fluid distribution member 128 or has otherwise been transferred toward or above a top surface of a seat assembly) from the top or front surface of the seating assembly toward a fluid module can provide one or more benefits or advantages. For example, such a configuration can allow placement of a fluid module 100 in an area within or near the seat assembly that would not otherwise have easy access to fresh air from the surrounding environment (e.g., cabin or interior of an automobile or other vehicle, room, etc.). In some arrangements, it may be desirable to place the fluid module (e.g., blower, other fluid transfer device, TED, heat transfer members, etc.) within, partially or completely, an encased area, cavity or other region in or near the seat assembly (e.g., a cushion, a mattress, box spring, another support member, etc.). Such a cavity or other region can be at least partially isolated from the surrounding air supply. Accordingly, climate controlled seat assemblies can include a more compact shape or any other desired configuration that they would without such features.

In addition, by directing into the inlet of a fluid module air or other fluid that is already thermally conditioned (e.g., cooled or heated air relative to ambient), the performance of the fluid module can be improved. For example, the operational efficiency of the fluid module (e.g., to condition and discharge air of a desired temperature) is increased, because, among other things, the temperature of the fluid entering the fluid module is closer to the desired discharge temperature than the temperature of ambient or surrounding air. Thus, the ΔT, the difference between the temperature (T₁) of the fluid entering the fluid module and the temperature (T₂) of the fluid exiting the fluid module, can be advantageously reduced.

With continued reference to FIG. 2, air can be drawn toward the inlet of a fluid module 100 through one or more inlet or intake vents 124 or other openings along the upper or front surface of the seat bottom portion 120 and/or seat back portion 130. This can provide the fluid module nearly invisible or otherwise hidden access to the surrounding cabin air or other ambient air. In some embodiments, the inlet vents or other openings 124 are located in relatively low pressure areas along the upper or front surfaces of the seat assembly. Placement of the vents 124 along areas of relatively low pressure, such as, for example, where there is reduced or no contact between the occupant and the seat assembly, can help ensure that air is adequately supplied through the intake vents 124 and any downstream passages 125 to the fluid module 100.

As discussed in greater detail herein, the inlet or intake vents or other openings 124 and other passages 125 that place the inlet of the fluid module 100 in fluid communication with air along the top or front surfaces of the seat assembly can comprise one or more cavities. In some embodiments, the cavities comprise removed portions of the assembly (e.g., foam or other cushion, mattress, other support member, etc.). Alternatively, such intake or inlet vents, cavities or other portions can be formed when the cushion, mattress and/or other support structure is being manufactured. In some embodiments, the vents, openings and/or other passages comprise one or more fluid permeable pads, scrims, spacer materials (e.g., spacer fabric, porous foam or other air permeable members, fluid-permeable honeycomb structures, etc.) and/or other members, either in addition to or in lieu of removed portions of the seat assembly (e.g., cushion, mattress, etc.).

With continued reference to FIG. 2, once it has passed to and through the fluid module 100, air or other fluid can be selectively heated or cooled using a thermoelectric device (TED), a convective heater, another thermal conditioning device (not shown) and/or the like. Such thermal or other environmental conditioning devices can be located or otherwise incorporated, at least in part, within a housing of the fluid module 100. Alternatively, one or more thermal or environmental conditioning members or devices can be located outside of a fluid module housing. Such thermal or environmental conditioning members or devices can form a unitary or monolithic structure with the fluid module. Alternatively, such members or devices can be separate and detached from the fluid module, but in fluid communication with it. The outlet of the fluid module 100 (e.g., main side outlet) can be directed through one or more passages 126 of the seat assembly 110 toward a downstream fluid distribution member 128. In some embodiments, a passage 126 is partially or completely formed within the foam of the seat bottom portion 120 and/or seat back portion 120. In other embodiments, however, the passage 126 comprises a duct or other conduit that does not extend through a portion of the seat's foam 122 or other support structure. For example, the passage 126 can include a conduit that is routed along the side or other exterior portion of the seat assembly 110. In still other embodiments, a seating assembly comprises a fluid module that is in fluid communication with one or more fluid distribution members without the use of passages or other intermediate conduits or members.

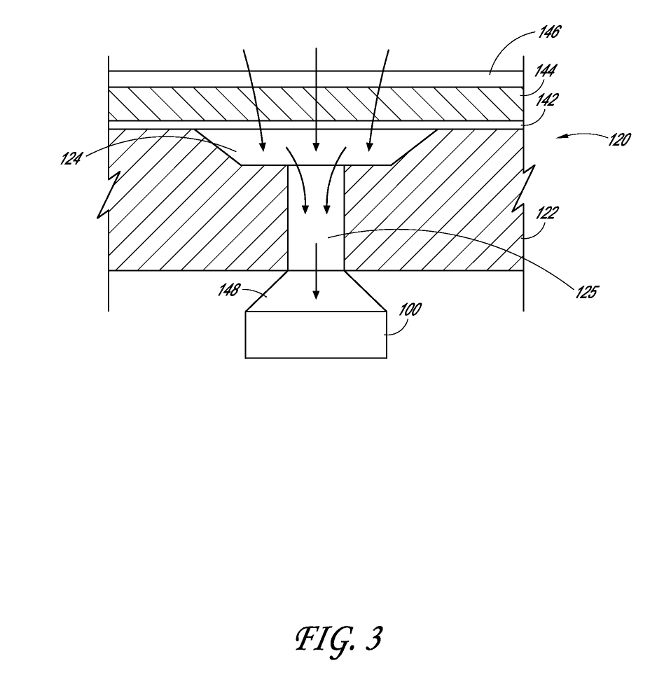

A partial cross-sectional view of one embodiment of a seat assembly configured to receive inlet air through or near its top or front surface is illustrated of FIG. 3. As shown, the foam pad, cushion or other support member 122 of a seat bottom or seat back portion can include one or more inlet or intake passages 125. According to some embodiments, the inlet passages comprise holes, openings, ducts, inserts and/or the like. The inlet passages 125 can be formed when the pad is being manufactured (e.g., injection molded or formed with such passages) or at a later time (e.g., after completion of the manufacture of the pad), as desired or required. For example, the inlet or intake passages can comprise portions of the cushion, mattress or other support member that are removed after formation of said support member. One or more recessed areas, pockets or other cavities 124 can be formed along the upper portion of the foam pad 122. The recessed areas 124 can facilitate the receipt and suction of air from and through the top or front surface of the seat assembly. Thus, as shown in FIG. 3, a recessed area 124 of the seating assembly can be in fluid communication with the adjacent fluid inlet or intake passages 125 of the cushion or other support member 122. However, in alternative arrangements, a seat assembly does not include any recessed areas 124.

The various embodiments of a top or front surface fluid inlet system disclosed herein as illustrated and described with reference to a vehicle seat having a foam pad or cushion. However, as noted above, the systems and features disclosed herein can be applied to any other seating assembly, regardless of whether or not it includes a foam pad or other type of cushion. For example, such systems and features can be incorporated into a climate-controlled bed assembly and/or any other seating assembly comprising latex, viscoelastic foam, other viscoelastic materials, air chambers, springs, comfort layers and/or any other types of materials or components.

With continued reference to the cross-sectional view of FIG. 3, one or more fluid permeable layers can be positioned on or along the top of the foam pad 122, cushion or other support member of the seat assembly. A seat assembly can include one or more scrim layers 142, spacer materials 144 (e.g., spacer fabric, honeycomb structure, another air permeable structure configured to at least partially maintain its shape when subjected to compressive forces, etc.), trim materials 146, outer fabric layers or other covering layers (not shown) and/or the like. Thus, as discussed in greater detail herein, air (e.g., at least a portion of which may be thermally or environmentally conditioned) can pass through such fluid permeable layers 142, 144, 146 and into one or more fluid passages or conduits 125 of the seat assembly. As shown in FIG. 3, the seat assembly can comprise one or more pockets or recessed areas 124 at or near the interface of the cushion or other support member 122 and the upper layers 142, 144, 146 of the assembly to facilitate movement of the air into the interior of the seat assembly.

Once it has entered into the inlet passages 125 or other fluid opening of the seat assembly, air or other fluid can pass to the inlet of a fluid module 100 (e.g., blower, other fluid transfer device, thermoelectric device, convective heater, heat exchange members, etc.). According to some embodiments, a funnel adapter 148 or other fitting can be positioned between the inlet passage 125 and the fluid module 100. Such a funnel adapter 148 can help direct the air toward the inlet of the fluid module 100, can help reduce fluid losses (e.g., assist in the hydraulics of delivering air or other fluid to the fluid module) and/or provide one or more other benefits or advantages. However, in other embodiments, another type of duct, conduit or fitting is used to place the inlet of the fluid module 100 in fluid communication with the passage(s) 125 of the seat assembly, either in addition to or in lieu of a funnel adapter 148 or similar feature or fitting. In some arrangements, the fluid module is secured directly to the bottom of the adjacent cushion (e.g., foam pad, other support member, etc.) so as to eliminate or reduce the need for a separate intermediate member (e.g., funnel adapter, other transition fitting, etc.).

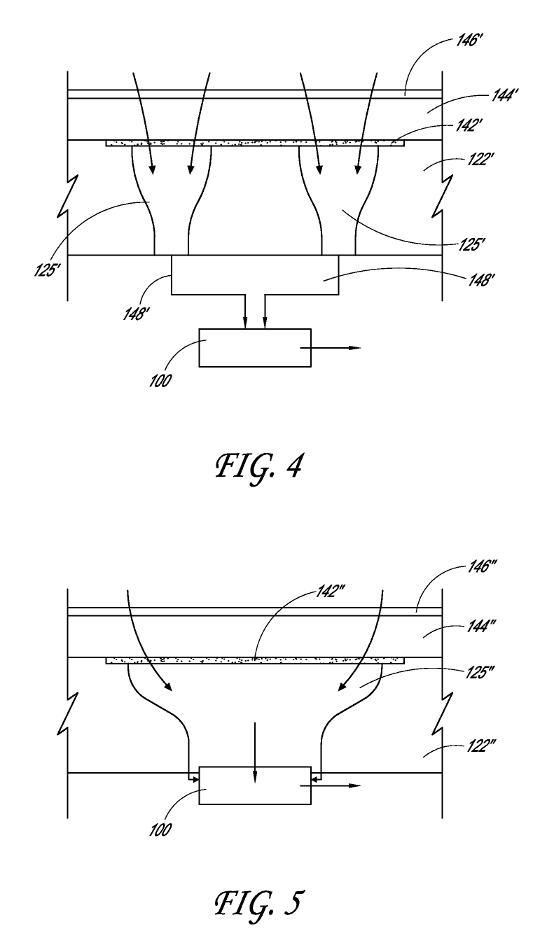

FIG. 4 illustrates another embodiment of a seat assembly portion (e.g., seat bottom or seat back) that is configured to allow air to be drawn from the top or front surface of the assembly toward the inlet of a fluid module 100. As discussed herein with reference to FIG. 3, the illustrated embodiment comprises one or more air permeable layers, sections or portions 142′, 144′, 146′ situated above a foam pad 122′, cushion or other support member. However, as shown in FIG. 4, a cushion 122′ or other support member can include two or more inlet passages 125′ situated therein. In the depicted arrangement, the inlet passages 125′ are identical or substantially identical to each other. However, in other embodiments, the size, shape and/or other characteristics of two or more of the inlet passages 125′ can be different from each other, as desired or required. Further, in other embodiments, more than two (e.g., three, four, five, more than five, etc.) inlet passages can be provided in a single cushion or other support member of a seat assembly. In FIG. 4, the inlet passages 125′ include a generally funnel, conical or trapezoidal shape, in that they have a larger cross-sectional area at their upper end and a relatively smaller or tapered cross-sectional area near the bottom. Such a configuration can facilitate the suction of air from the top or front surface of the seat assembly (e.g., by reducing friction or head losses), can reduce noise or vibration and/or provide one or more other benefits or advantages. To assist with delivery of air into the inlet passages 125′, the seat assembly can include one or more recessed areas, sections, regions and/or pockets (FIG. 3), either in addition to or in lieu of the tapered inlet passage design. However, in any of the embodiments disclosed herein, the inlet fluid passages 125′ can comprise a generally cylindrical design or any other shape, as desired or required.

With continued reference to FIG. 4, a scrim layer 142′ and/or other generally air permeable layer or portion can be positioned between the support structure 122′ (e.g., foam pad, cushion, etc.) and the adjacent layers (e.g., spacer fabric or other spacer material 144′, trim 142′, outer fabric or other covering, etc.). In the depicted arrangement, a single scrim layer 142′ extends across (e.g., and thus, is in fluid communication with) both inlet passages 125′. Alternatively, a seat assembly can include two or more scrim layers 142′ or similar air permeable portions (e.g., one along the top of each inlet passage 125′). Once air has passed from the upper or front surface of the seat assembly through the various air-permeable layers 142′, 144′, 146′ and through one or more inlet passages 125′ or other portions of the seat assembly, it can be directed to the inlet of a fluid module 100. In any of the embodiments disclosed herein, a seat assembly can include two or more different fluid modules into which air at least partially originating from a top or front surface of the assembly can be directed. In some embodiments, as schematically illustrated in FIG. 4, one or more intermediate members 148′, such as, for example, funnel adapters, conduits and/or the like, are used to help direct inlet air or other fluid from the bottom of the inlet passages 125′ to the fluid module 100.

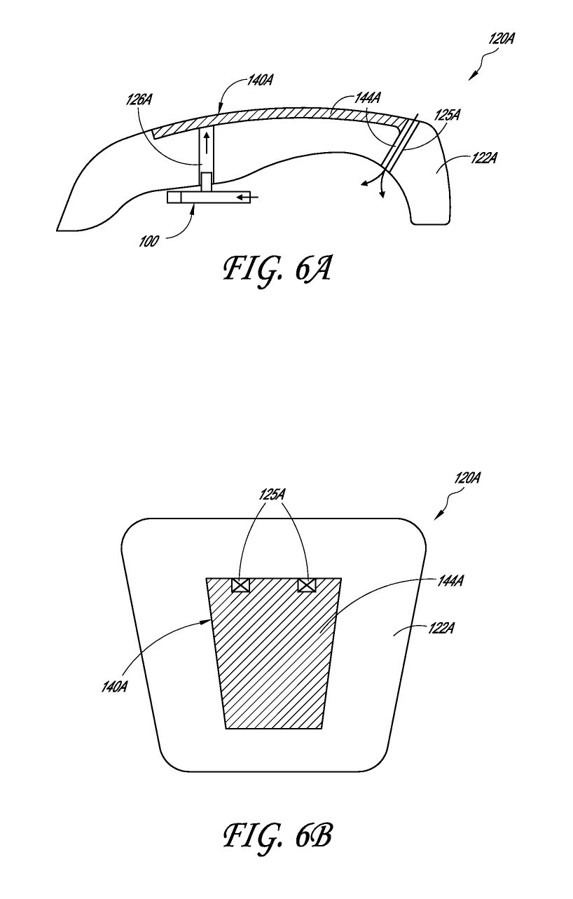

Alternatively, as illustrated in the cross-sectional view of FIG. 5, a seat assembly can include only a single funnel or cone-shaped inlet passage 125″ that extends through the support member or structure 122″ (e.g., foam pad, other cushion member, mattress, etc.). In addition, for any of the embodiments disclosed herein, the need for an intermediate member that places the inlet of the fluid module in fluid communication with the seat assembly (e.g., inlet passages, air permeable layers, etc.) can be eliminated. For example, as shown in FIG. 5, the fluid module 100 can be positioned against or near the inlet passage 125″. In some embodiments, the fluid module 100 is situated at least partially within the inlet passage 125″.

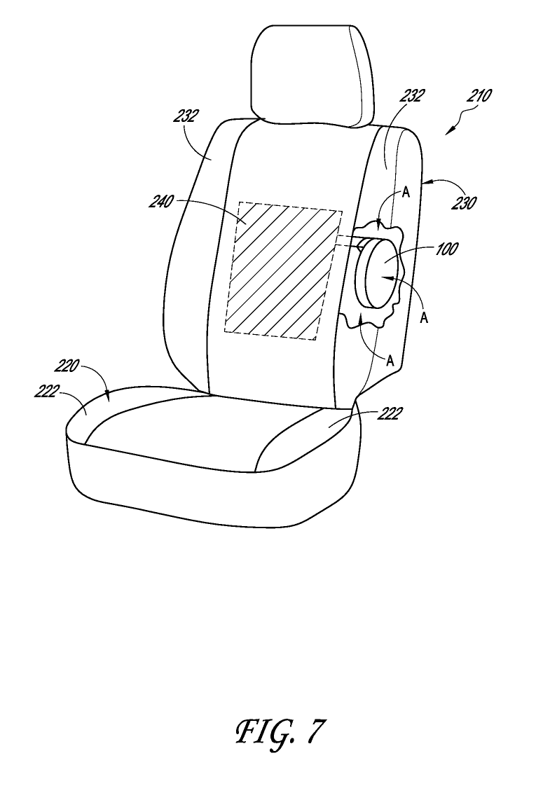

With reference to the embodiment illustrated in FIGS. 6A and 6B, a seat bottom portion 120A of a seating assembly can include one or more inlet passages 125A that are configured to convey air from a top or front surface of the seat assembly to a region below the foam pad 122A or other support structure or member. As discussed in greater detail above, such a design can be incorporated into the seat back portion of the seat assembly, either in lieu of or in addition to the seat bottom portion. Further, these recirculation features and adaptations can be incorporated into any other type of seating assembly, such as, for example, a climate-controlled bed, wheelchair, sofa other type of seat and/or the like. In the depicted embodiment, the seat bottom portion 120A comprises a total of two inlet passages 125A that have a generally rectangular cross-section and that are situated along one edge of the seat's air permeable region (e.g., conditioner mat 140A, the area covered by a spacer fabric or other air-permeable material 144A, etc.). Alternatively, however, the quantity, spacing, size, location, shape, orientation and/or other characteristics of the inlet passages 125A can vary, as desired or required. By way of example, the seat assembly can include fewer (e.g., one) or more (e.g., three, four, more than four, etc.) inlet passages 125A. Further, the inlet passages 125A can be spaced along opposite edges or portions of the conditioner mat 140A or other air permeable region and/or can include a circular or oval cross-sectional shape.

With continued reference to FIGS. 6A and 6B, the inlet passages 125A can be extensions of the conditioner mat 140A and the corresponding recessed region formed along the upper portion of the cushion 122A (e.g., foam pad member). As shown in FIG. 6A, in order to help maintain the shape and integrity of the inlet passages 125A, one or more spacer fabrics or other spacer materials 144A can be positioned, at least partially, within the inlet passages 125A. Such a spacer fabric or other air-permeable material can be generally continuous with the spacer fabric included within the conditioner mat 140A. Alternatively, however, the spacer fabric 144A included within the inlet passages 125A can be different and/or separate from the spacer fabric 144A used within the conditioner mat 140A or any other portion of the climate controlled seat assembly (for example, the different spacer fabrics or materials can comprise a different air permeability; e.g., the air permeability of one spacer material can be greater than the other spacer material by about 1%, 2%, 5%, 10%, 15%, 20%, greater than 20%, less than about 1%, percentages between the foregoing ranges, etc.). In other embodiments, one or more of the inlet passages 125A do not include a spacer material or any other item therein. In order to help maintain the integrity of the inlet passages 125A during use, the inlet passages 125A can include a lining, coating, conduit, insert and/or the like. Such devices and/or materials can help make the inlet passages more air impermeable to avoid leaks and other unintended fluid losses, can help reduce fluid losses and/or provide one or more other advantages or benefits, as desired or required.

As illustrated in FIG. 6A, once air from or near the top or front surface of the seat assembly has passed through the inlet passages 125A (and possibly through at least a portion of a conditioner mat 140A and/or other air permeable member or layer) to a region below the cushion (e.g., the foam pad or other support structure of the seat bottom portion or the seat back portion), it can be directed toward the inlet of one or more fluid modules 100. As noted above, at least a portion of the air drawn into the inlet passages 125A and toward the fluid module 100 can be thermally-conditioned (e.g., heated, cooled, etc.), as desired or required. This type of recirculation can improve the efficiency and overall performance of the fluid module. In some embodiments, the operational efficiency of the fluid module can be increased by approximately 1%, 5%, 10%, 15%, 20%, 25%, 30%, 40%, 50%, greater than about 50%, less than about 1%, percentages between the foregoing values, etc. The fluid module 100 can selectively deliver air or other fluid through one or more passages 126A of the seat assembly toward the conditioner mat 140A, and ultimately, in the direction of a seated occupant (not shown). In some embodiments, the delivery of air or other fluids by the fluid module 100 through the outlet passages 126A of the seat assembly creates a vacuum pressure (e.g., negative or lower pressure relative to ambient, atmospheric pressure) within at least a portion of the region below the support structure 122A (e.g., cushion, mattress, etc.). Accordingly, the generation of such a suction or vacuum force can assist in drawing air through the inlet passages 125A from the top or front of the seat assembly. In addition, as illustrated in FIG. 6A, at least a portion of the air entering the inlet passages 125A can comprise environmentally-conditioned (e.g., heated, cooled, dehumidified, etc.) air that has entered into and generally has not escaped the conditioner mat 140A (e.g., from the fluid module and the outlet passages 126A).

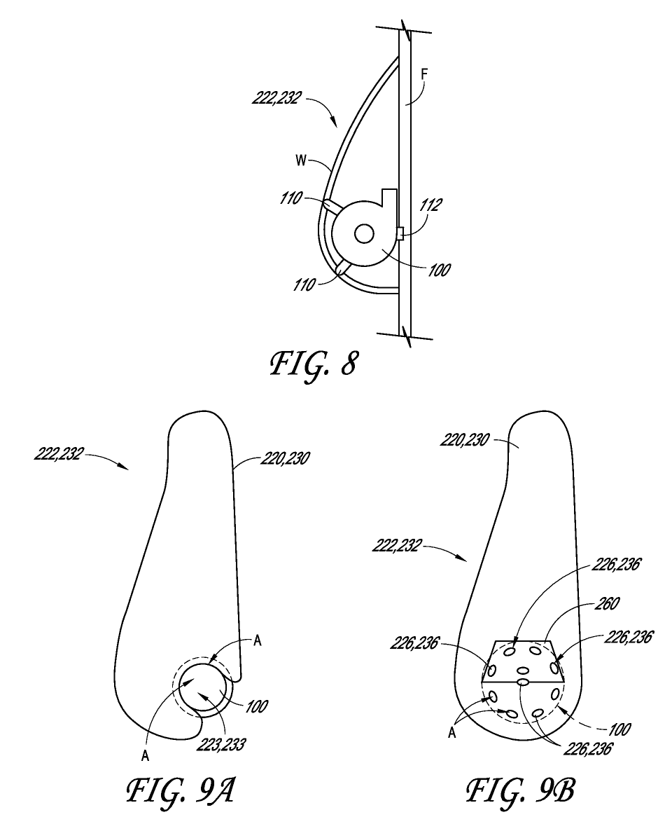

In some embodiments, as illustrated in FIG. 7, a fluid module 100 is advantageously positioned within a bolster 222, 232 or other side portion of a seat assembly 210. In the depicted embodiment, a fluid module has been included in or near one of the bolsters of the seat assembly's seat back portion 230. However, in other embodiments, one or more fluid modules can be located in or near any other bolster 222, 232 or any other portion of the seat back portion 230 and/or seat bottom portion 220, as desired or required. In embodiments where it is desired to direct air from a seat assembly's upper or front surface to an inlet of a fluid module, as described in various arrangements disclosed herein, the bolsters 222, 232 or adjacent areas or regions can be particularly advantageous locations to house such a fluid module (e.g., blower, other fluid transfer device, thermoelectric device, convective heater, other heating or cooling device or item, heat transfer members, etc.). For example, in some seat assembly arrangements, bolsters 222, 232 are positioned along either side of the seat bottom portion 220 and the seat back portion 230, and thus, are subjected to lesser degree of continuous contact with an occupant. Accordingly, as illustrated in FIG. 7, certain areas or portions of the bolsters 222, 232 can be targeted to allow air A from or near the upper, front or side surfaces of the seat assembly to enter an inlet of the fluid module 100. As discussed with reference to other embodiments herein, once within the fluid module, air (e.g., a portion of which may be air that was previously conditioned and discharged by the same and/or a different fluid module associated with the seat assembly) can be transferred into one or more conditioner mats 240 or other fluid distribution members.

In other embodiments, air or other fluid can be drawn into the inlet of a fluid module 100 through a conduit or other fluid passageway or connection extending at least partially between the conditioner mat 240 and the fluid module. Thus, with reference to FIG. 7, air A can be directed from the conditioner mat 240 (e.g., spacer fabric or other spacer material, other air permeable layers, etc.) to the fluid module 100, in addition to or in lieu of any other inlets (e.g., along the side or front of the bolsters).

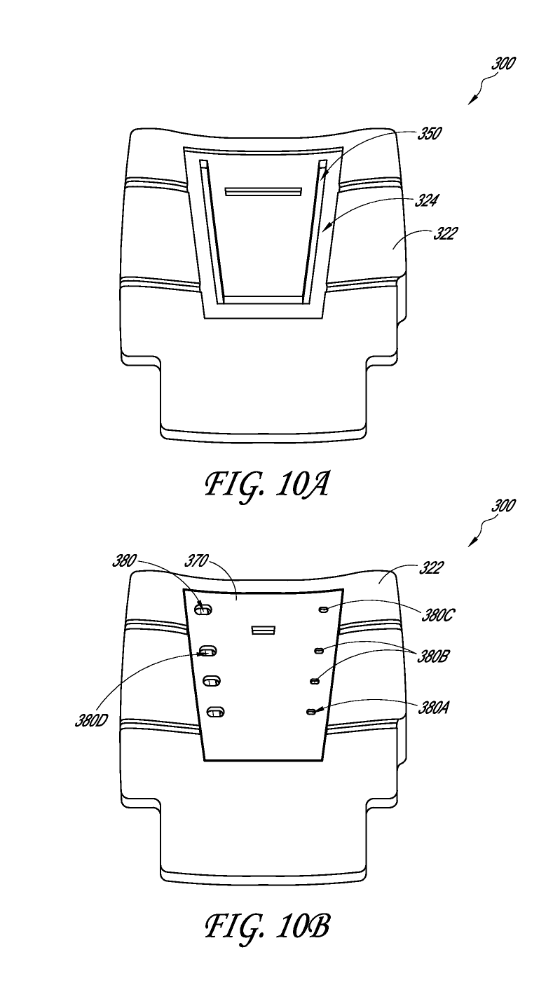

FIG. 8 illustrates one embodiment of a fluid module 100 positioned within or near the bolster 222, 232 of a seat assembly's seat bottom or seat back portion 220, 230. As shown, the fluid module 100 can be secured to the seat assembly at one or more locations. For example, plates, tabs or other extensions 110, 112 of the fluid module housing can be sized, shaped, oriented, spaced and otherwise configured to attach to a wire W or other surface or structure of the bolster 222, 232 and/or a seat frame F. Such tabs or other mounting features can be connected to the bolster wire W, seat frame F and/or other support structure using one or more screws, rivets, other fasteners, adhesives, welds and/or any other attachment device or method.

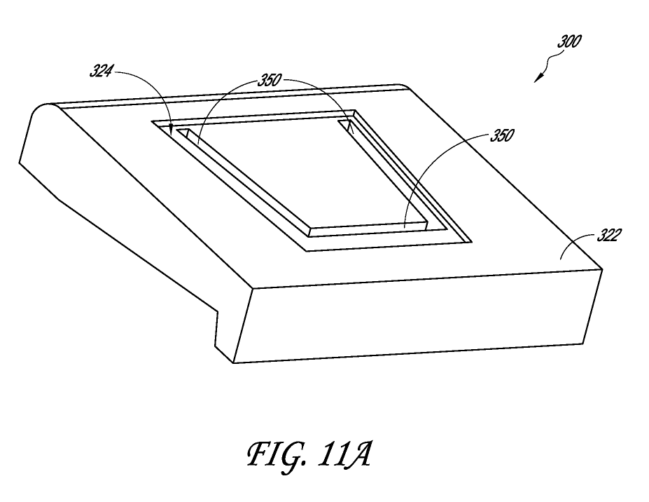

According to some embodiments, the seat bottom portion 220 or seat back portion 230 of a seating assembly can include one or more cutouts, recesses, cavities and/or similar features in order to facilitate the passage of air or other fluid toward one or more fluid modules of the seating assembly (e.g., vehicle seat, bed, etc.). For example, as illustrated in FIG. 9A, a cutout 223, 233 can be formed within or near the bolster 222, 232 of the seat assembly by cutting or otherwise removing a portion of the cushion (e.g., foam pad). In some arrangements, the bolster 222, 232 is manufactured (e.g., injection molded) with one or more such cutouts 223, 233. Alternatively, the cutouts 223, 233 can be formed after the bolsters 222, 232 have been manufactured (e.g., by removing, reshaping or otherwise altering a cushion or other support member, as part of a separate subsequent step or procedure, etc.).

Regardless of their exact configuration and other details, such cutouts 223, 233 can facilitate the delivery of air A into the inlet of an adjacent fluid module 100 through the side of the bolster 222, 232. The cutouts can include any shape (e.g., generally circular, oval, elliptical, square, other rectangular, other polygonal, irregular, etc.). Further, the length, depth, diameter and/or other dimension or sizing feature of the cutouts can be varied in accordance with a desired design or configuration. In some embodiments, one or more covering fabrics, layers and/or materials can be positioned at least partially along the cutout 223, 233 to hide and/or protect the fluid module 100. Such fabrics, layers and/or other materials can be air permeable to permit air or other fluids to pass therethrough. In some embodiments, such fabrics, layers and/or other materials can be semi-rigid or rigid to provide a necessary degree of protection to the underlying fluid module(s). One or more space materials (e.g., spacer fabrics, porous foam members, etc.) can be positioned, at least partially, within one or more cutouts, as desired or required.

According to some embodiments, the bolster 222, 232 does not include a larger cutout 223, 233 (e.g., as illustrated in FIG. 9A). Instead, as shown in FIG. 9B, the bolster 222, 232 can include a plurality of smaller openings or vents 226, 236 through which air or other fluid may pass. Such openings 226, 236 can be formed within the cushion or other support member (e.g., foam pad, mattress, etc.) and/or any other layers or members that help form the seat bottom or seat back portion 220, 230 (or other portion of a seat assembly) in the vicinity of the fluid module 100. As illustrated in FIG. 9B, the region near the fluid vents or other openings 226, 236 can include a bezel 260 or other covering to help protect the openings 226, 236, the underlying fluid module and/or any other portion or component of the seat assembly. Further, such a covering 260 can help direct air through openings 226, 236 in a desired direction. In any of the embodiments disclosed herein, one or more filters or other similar devices can be placed upstream of the fluid module (e.g., at or near the inlet of the fluid module, within an inlet passage or other interior portion of the seat assembly, along the outside of the seat assembly and/or at any other location), as desired or required. Such filters or other devices or members can help at least partially clean the air being conditioned by the fluid modules, keep out potentially harmful materials or objects from an interior of the assembly and/or provide any other benefit or advantage.

According to some embodiments, as noted herein, a cushion or other support member for a seat assembly (e.g., vehicle seat, other seat, bed, wheelchair, etc.) comprises one or more channels that are configured to receive and at least partially distribute air or other fluid in a desired manner. Such channels or other fluid pathways can be formed along the front (or upper) surface of the cushion or other support member (e.g., mattress). However, in alternative embodiments, the channels are located along the back (or lower) surface of the cushion or other support member. In yet other arrangements, the channels or pathways can be located within an interior portion of the cushion or support member (e.g., away from both the front and back surfaces), as desired or required. Regardless of their exact orientation, size, shape, spacing, location and/or other details, such channels can help distribute fluids (e.g., thermally conditioned air, ambient air, etc.) exiting a fluid module (e.g., blower, thermoelectric device, etc.) to selected portions of a seat assembly (e.g., to specific or general areas occupied by one or more seated occupants). For example, in some embodiments, the channels extend along the seat back portion of a seat assembly and/or the seat bottom portion of a seat assembly. In other embodiments, the channels extend along a left side, a right side, a middle portion and/or any other area of a mattress or other support structure of a bed or any portion of another type of seating assembly (e.g., wheelchair, sofa, etc.).

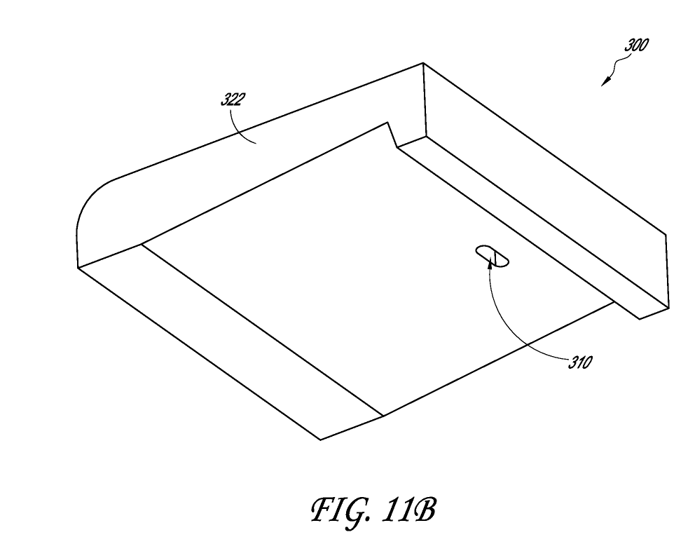

According to some embodiments, as illustrated in FIGS. 10A, 11A-11C and 12, a cushion 322 or other support structure of a seating assembly 300 (e.g., a seat back or seat bottom portion 320 of a vehicle seat, a bed, etc.) comprises one or more fluid channels 350 along or near its upper surface. As shown, the fluid channels 350 can generally form a U-shape toward the middle portion of the cushion 322, so that fluid (e.g., thermally conditioned air, ambient air, etc.) can be selectively delivered to an occupant when the seating assembly is in use. However, the channels can form any other shape (e.g., H-shape, circular or oval shape, rectangular or other polygonal shape, irregular shape, etc.) in accordance with a desired or required fluid distribution pattern. The channels 350 can be formed at the time that the cushion 322 or other support structure (e.g., mattress) is manufactured (e.g., as part of an injection molding process, other molding procedure, etc.). Alternatively, the channels 350 can be formed after the cushion 322 or other support structure has been manufactured. For example, material can be excised and removed from the cushion or other support member in order to form the channels.

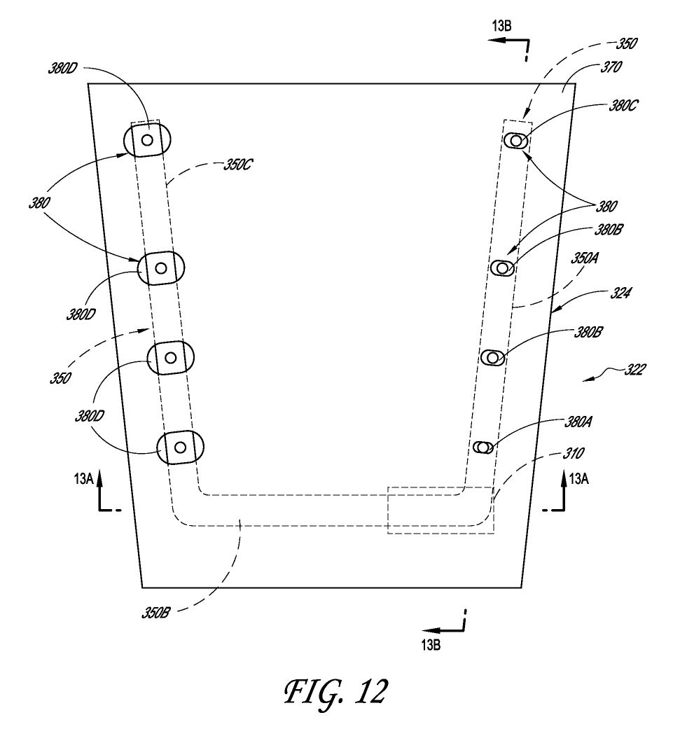

As illustrated in FIG. 10B, a scrim 370 or similar member can be shaped, sized and otherwise configured to be positioned at least partially (e.g., partially or completely) over the open channels 350 of the cushion 322. In some embodiments, the scrim 370 and/or other covering member is adapted to generally fit within a recessed area 324 or gap formed along the top surface of the cushion 322 or other support structure of the seat assembly. The fit or tolerance between the scrim 370 and the edges of the adjacent recess of the seat assembly can be snug or loose, as desired or required. The scrim 370 can form an upper boundary to the channels 350 to at least partially enclose them, thereby forming one or more fluid passages within the seat assembly. With continued reference to FIG. 10B, the scrim can include one or more holes or other openings 380A, 380B, 380C, 380D through which air or other fluid can exit the channels 350 and the corresponding fluid passageways formed by the channels and scrim. As shown in FIGS. 10B and 12, the openings can vary in size, shape, spacing, orientation and/or any other manner in order to provide a desired flow conditioning pattern and/or thermal or environmental conditioning scheme to the climate control seating assembly. Likewise, one or more properties of the fluid channels (e.g., channel width, depth, length, shape, surface covering, etc.) can be varied to accomplish the desired fluid and/or thermal conditioning for a seating assembly.

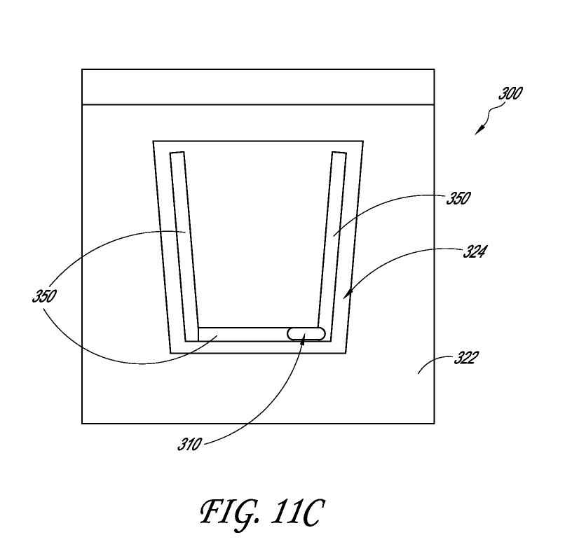

According to some embodiments, as illustrated in FIGS. 11A-11C, the passage or conduit 310 passing through the cushion 322 or other support member of the seat assembly 300 (e.g., vehicle seat, bed, etc.) is offset. In other words, the passage 310 is not aligned with the horizontal centerline of the cushion 322 (or other support member) and/or the channels 350 and corresponding fluid passageways formed therein. As noted herein, the fluid passage 310 or other conduit can place one or more fluid modules in fluid communication with the seat assembly's channels 350. Therefore, as best seen in the top view of FIG. 11C, according to some embodiments, the passage 310 (or entry point into the channels 350) is non-symmetrical relative to the channels 350 formed along the top and/or any other portion of the cushion 322. In some arrangements, such an offset or non-symmetrical alignment of the passage 310 (e.g., relative to the cushion, channels, etc.) can result from design considerations related to the placement of the fluid module relative to the seat back or seat bottom portion of a seat assembly. For example, such an offset alignment may be required by space limitations along certain regions along or near the rear and/or bottom sides of a seat assembly.

Regardless of the exact reasons for an offset passage 310, the shape, size, location, orientation, shaping, slope and/or other characteristics of the passage 310, the channels 350 (and the corresponding fluid passageways formed thereby), the openings 380 along the scrim 370 or other layer and/or any other portions of the seat assembly can be varied in order to balance or substantially balance the airflow distribution (e.g., hydraulically balance) and/or temperature along the exterior surface of a cushion. Thus, in some embodiments, irrespective of where the passage 310 is positioned relative to the cushion, the overall feel to a seated occupant (e.g., with respect to airflow and/or temperature) remains fairly evenly distributed and generally consistent. As a result, the overall comfort level to the occupant can be advantageously improved and/or otherwise enhanced.

FIG. 12 illustrates a top view of one embodiment of a cushion 322 having fluid channels 350 along an exterior (e.g., upper or top) surface and a passage 310 that is generally offset or non-symmetrical relative to the channels 350. As discussed above with reference to FIGS. 10A, 10B and 11A-11C, the depicted channels 350 can be positioned within a recessed area 324 along the top or front surface of a seat cushion. Further, a scrim 370 or other covering member or layer can be positioned above the channels 350 in order to define certain fluid passages therebetween. In some arrangements, as illustrated in FIG. 12, the scrim 370 or other covering member is generally configured to fit within the recessed area 324 of the cushion.

In some embodiments, in order to hydraulically balance or substantially hydraulically balance the airflow passing through the channels 350 (and the corresponding fluid passageways formed thereby) and exiting through the openings 380 of the scrim 370, the shape and/or size of the channels 350 and/or the openings 380 of scrim 370 can vary. For example, air or other fluid passing from a fluid module and through a passage of the cushion would exit through the openings in a manner that reduces or minimizes friction losses (e.g., hydraulic head losses or pressure losses). As a result, in such offset configurations (e.g., where the passage 310 is not symmetrical with the channels 350), more air would tend to flow into channels 350 that are closer to the passage 310. Likewise, relatively more air would exit through the openings 380 that are located near the passage. This can create a generally unbalanced hydraulic airflow scheme along one or more exposed surfaces of the seat assembly, thereby reducing the level of comfort and reducing the level of environmental conditioning to a seated occupant.

Therefore, in order to improve the level of comfort and to improve the performance of climate-controlled seating assembly, any seating assembly (e.g., vehicle seat, other seat, bed, etc.) disclosed herein or equivalents thereof can comprises an offset fluid passage 310 through the cushion or other support structure of the assembly. In some of such arrangements, the cross-sectional size of the fluid distribution channels 350 can generally increase with increased distance from the entry point of the passage 310 into the channel network. With continued reference to the embodiment illustrated in FIG. 12, a cushion 322 can include a generally continuous channel 350 having three separate legs, branches or portions (e.g., left branch, middle branch and left branch). In some embodiments, such legs or branches of the channels 150 can form a generally U-shape along one or more portions of the seat assembly. As noted herein, in other arrangements, the overall shape and design of the channels can vary, as desired or required. For instance, the quantity, shape, size, orientation, spacing and/or other details of the legs or branches can be different than depicted herein.

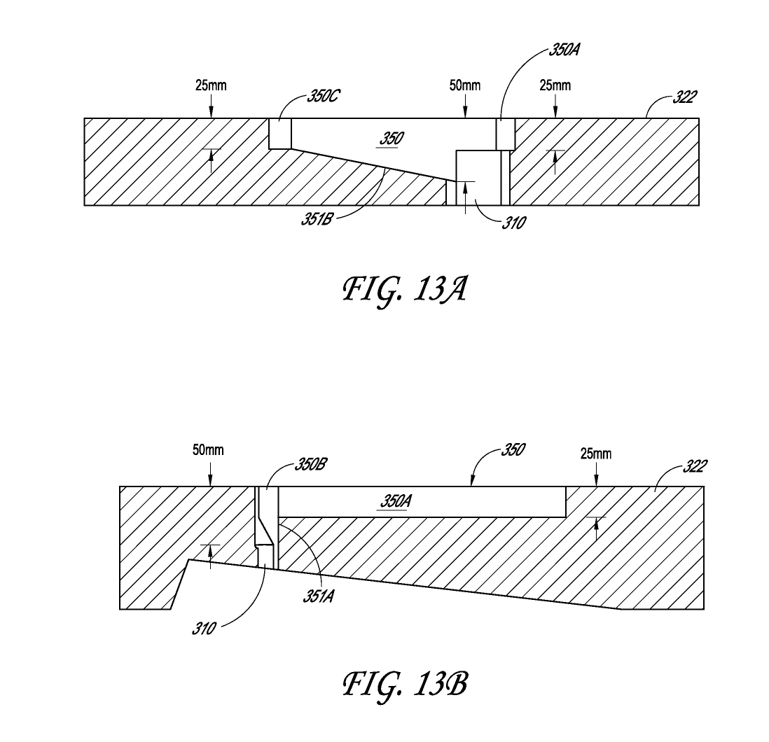

According to some embodiments, as illustrated, for example, in FIGS. 12 and 13B, the right branch 350A or portion of the channel 350 is approximately 16 mm wide and approximately 25 mm deep, with a generally rectangular cross-sectional shape. In addition, the middle branch 350B or portion of the channel 350 can be approximately 20 mm wide. As best depicted in the cross-sectional view of FIG. 13B, a relatively steep vertical step 351A can be included at or near the interface of the right and middle channel segments 350A, 350B. However, in alternative arrangements, such a transition can be generally rounded or smoothed. For example, in some arrangements, as illustrated in the cross-sectional view of the middle branch 350B in FIG. 13A, the bottom wall 351B of other surface of the channel can be sloped. Such a slope feature can help to further reduce head losses of air conveyed from the passage 310 to the middle and left branches or portions 350B, 350C of the fluid channels 350. Sloped walls or surfaces can be provided in any other branch, segment or portion of the channels 350, as desired or required. Such surfaces can have a constant slope or a varying one. With continued reference to the cross-sectional view of FIG. 13A, the sloped bottom surface 351B can extend from a depth of approximately 50 mm nearest the passage 310 to a depth of approximately 25 mm at or near the left branch or segment 350C of the channels 350. In some embodiments, the slope of a bottom surface of a channel can vary between 0 and 90 degrees (e.g., about 0, 5, 10, 15, 20, 25, 30, 35, 40, 45, 50, 55, 65, 70, 75, 80, 85, 90 degrees, slopes between the foregoing values, etc.), as desired or required. Therefore, in some embodiments, the depth and/or width of a fluid channel (as measured from the top surface of a cushion or other support member in which the channel is formed) can vary by about 5%, 10%, 15%, 20%, 25%, 30%, 35%, 40%, 45%, 50%, 55%, 60%, 65%, 70%, 75%, 80%, 85%, 90%, 95%, 100%, more than about 100%, less than about 5%, percentages in between the foregoing values, etc. from one location of a channel to another (e.g., regardless of whether it is the same of a different branch of leg of the channel).

According to some embodiments, the left branch or segment 350C can include a width of approximately 18 mm and a depth of approximately 25 mm, with a generally rectangular cross-sectional shape. The embodiment illustrated in FIG. 12 and discussed in greater detail above described only a single embodiment of a fluid channel scheme incorporated into a cushion with an offset passage. However, in other embodiments, the quantity, shape (e.g., cross-sectional shape), size (e.g., width, depth, length, etc.), spacing, orientation and/or other details of the fluid channels can be varied to achieve a desired airflow distribution and/or thermal conditioning scheme.

In some arrangements, the passage 310 and/or the surfaces that define the various channel 350 portions can include a coating, layer or the like. Such coatings or layers can help improve the air impermeability of the passage and/or the fluid channels, can help reduce friction losses as air passes through such channels and/or provide any other goal or benefit, as desired or required. In other embodiments, one or more inserts, spacer materials (e.g., spacer fabrics, air permeable foams, honeycomb structures, etc.) can be positioned, within at least partially along a length of the channels and/or the passage to reduce fluid losses therethrough. Such liners and/or air permeable materials can help ensure the integrity of the channels during use (e.g., to reduce or minimize the likelihood of channel collapse as a result of occupant contact and pressure), to help more evenly distribute fluids that enter the fluids and/or the like.

With continued reference to FIG. 12, the scrim 370 or other top member or layer that is configured to cover the channels 350 can include a plurality of openings 380. Thus, air or other fluids passing through the fluid passageways defined between the channels 350 and the adjacent scrim 370 (or over cover member) can exit toward the top or front of the cushion 322 or other support member (e.g., mattress) through such openings 380. In the depicted embodiment, the scrim 370 includes a total of eight holes or fluid openings 380. As shown, one or more of the fluid openings 380 can vary in shape and/or size from other scrim openings 380. For example, in FIG. 12, all of the openings 380 have a generally oval shape, with one cross-sectional dimension being larger than the other. However, in other embodiments, the quantity, shape, size, orientation and/or other details of the openings 380 can vary, as desired or required. For instance, a scrim can include fewer or more than eight openings 380 (e.g., one, two, three, four, five, six, seven, nine, ten, twelve, fourteen, eighteen, twenty, thirty, more than thirty, values between such ranges, etc.). In other arrangements, one or more of the openings can include a circular, polygonal (e.g., square, rectangular, triangular, hexagonal, octagonal, etc.) shape, irregular and/or the like. In addition, in the illustrated embodiment, the openings are generally equally spaced apart adjacent only the left and right channel segments 380C, 380A. Alternatively, however, openings can be positioned adjacent the middle segment and/or any other portion of the channels, either in addition to or in lieu of the left and right segments. In some embodiments, the diameters of each of the exit holes or opening 380 increases with increasing distance from the inlet passage 310. Such a configuration can help with a more even hydraulic distribution of air or other fluids passing through the channels 350 (e.g., as the larger openings are associated with a lower pressure loss relative to the smaller openings). According to some embodiments, the cross-sectional area of one opening 380 can be about 10%, 20%, 30%, 40%, 50%, 100%, 200%, 300%, 400%, 500%, 600%, 700%, 800%, 900%, 1000%, 2000%, 3000% smaller or larger, less than about 10% larger or smaller, more than about 3000% smaller or larger, percentages between the foregoing values, etc. than the cross-sectional area of another opening in the same channel.

As noted above and illustrated in FIG. 12, the scrim openings 380 can vary in size. In some embodiments, such size variations can further help to create a generally balanced airflow and/or temperature distribution along an upper or front surface of the seat assembly. For example, with reference to the arrangement of FIG. 12, the scrim openings 380 located adjacent the right segment 350A of the channels 350 are generally smaller than the scrim openings 380 located adjacent the left segment 350C. In some embodiments, the right side of the scrim 370 includes oval openings 380C, 380B, 380A that are approximately 7 mm by 11 mm, 10 mm by 14 mm (two of them) and 8 mm by 12 mm. In contrast, in the illustrated embodiment, the openings 380D along the left side of the scrim 370 are all approximately 20 mm by 30 mm. According to some embodiments, making the openings 380D that are wider than the width of the adjacent channel 350C can improve the air transfer through such openings 380D (e.g., by reducing friction or other fluid pressure losses).

Any of the embodiments of an environmental conditioning device disclosed herein, or equivalents thereof, can be used in conjunction with a thermoelectric device (e.g., Peltier device), a convective heater and/or any other thermal-conditioning device. Thus, a climate control system of a seating assembly can include a thermoelectric device, a convective heater, any other cooling, heating and/or ventilation device and/or the like, as desired or required. Further, a climate control system can be adapted to simply provide air or other fluids to one or more portions of a seat assembly that are not thermally conditioned (e.g., ambient air for ventilation purposes only). Accordingly, a climate control system that incorporates an environmental conditioning device according to any of the embodiments disclosed herein can be adapted to selectively provide cooled, heated and/or ventilated air by activating one or more thermal conditioning devices and delivering air or other fluids through, past or near it. However, the same climate control system can provide non-thermally conditioned air by delivering air or other fluids (e.g., via a fluid transfer device) while the heating device is deactivated. Thus, ventilated air or other fluids can be delivered to a climate controlled seat assembly to provide some level of comfort to a seated occupant.

Additional disclosure regarding climate-controlled seats, beds and other assemblies is provided in U.S. patent application Ser. Nos. 08/156,562 filed Nov. 22, 1993 (U.S. Pat. No. 5,597,200); 08/156,052 filed Nov. 22, 1993 (U.S. Pat. No. 5,524,439); 10/853,779 filed May 25, 2004 (U.S. Pat. No. 7,114,771); 10/973,947 filed Oct. 25, 2004 (U.S. Publ. No. 2006/0087160); 11/933,906 filed Nov. 1, 2007 (U.S. Publ. No. 2008/0100101); 11/872,657 filed Oct. 15, 2007 (U.S. Publ. No. 2008/0148481); 12/049,120 filed Mar. 14, 2008 (U.S. Publ. No. 2008/0223841); 12/178,458 filed Jul. 23, 2008; 12/208,254 filed Sep. 10, 2008 (U.S. Publ. No. 2009/0064411); 12/505,355 filed Jul. 17, 2009 (U.S. Publ. No. 2010/0011502); and U.S. Provisional Application No. 61/238,655 filed Aug. 31, 2009, all of which are hereby incorporated by reference herein in their entireties.

To assist in the description of the disclosed embodiments, words such as upward, upper, bottom, downward, lower, rear, front, vertical, horizontal, upstream, downstream have been used above to describe different embodiments and/or the accompanying figures. It will be appreciated, however, that the different embodiments, whether illustrated or not, can be located and oriented in a variety of desired positions.

Although the subject matter provided in this application has been disclosed in the context of certain specific embodiments and examples, it will be understood by those skilled in the art that the inventions disclosed in this application extend beyond the specifically disclosed embodiments to other alternative embodiments and/or uses of the subject matter disclosed herein and obvious modifications and equivalents thereof. In addition, while a number of variations of the inventions have been shown and described in detail, other modifications, which are within the scope of these inventions, will be readily apparent to those of skill in the art based upon this disclosure. It is also contemplated that various combinations or subcombinations of the specific features and aspects of the embodiments may be made and still fall within the scope of the inventions disclosed herein. Accordingly, it should be understood that various features and aspects of the disclosed embodiments can be combine with or substituted for one another in order to form varying modes of the disclosed inventions. Thus, it is intended that the scope of the subject matter provided in the present application should not be limited by the particular disclosed embodiments described above, but should be determined only by a fair reading of the claims that follow.

1. A climate controlled seat assembly, comprising:
a cushion positioned along a seat bottom portion or a seat back portion of the seat assembly, said cushion having a first surface configured to contact an occupant and a second surface generally opposite of the first surface, a cushion depth extending between the first surface and the second surface;
at least one fluid passage positioned and routed at least partially through the cushion depth, said at least one fluid passage extending to the second surface of the cushion;
at least one fluid module comprising a fluid transfer device and a thermal conditioning device configured to selectively thermally condition air and to transfer said thermally conditioned air through the at least one fluid passage, said at least one fluid module comprising an inlet and an outlet;
wherein the outlet of the at least one fluid module is in fluid communication with the at least one fluid passage;
a fluid distribution region positioned along or near the first surface of the cushion, said fluid distribution region configured to receive thermally conditioned air from the at least one fluid passage and to at least partially distribute said thermally conditioned air along the first surface of the cushion; and
at least one recirculation fluid passage configured to return at least a portion of the thermally conditioned air discharged by the fluid distribution region toward the inlet of the fluid module;
wherein said at least one recirculation fluid passage places the at least one fluid module in fluid communication with an area adjacent the first surface of the cushion.

2. The seat assembly of claim 1, wherein the at least one recirculation fluid passage extends at least partially through an interior portion of the cushion.

3. The seat assembly of claim 1, wherein the at least one recirculation fluid passage extends at least partially through an exterior portion of the cushion.

4. The seat assembly of claim 1, further comprising at least one vent region situated between the first surface of the cushion and the at least one recirculation passage, said at least one vent region being configured to enhance the receipt of recirculated air into the at least one recirculation passage from along the first surface of the cushion.

5. The seat assembly of claim 4, wherein the at least one vent region comprises a recess along the first surface of the cushion.

6. The seat assembly of claim 4, wherein the at least one vent region comprises a funnel or conical shape.

7. The seat assembly of claim 1, wherein the at least one recirculation passage originates in or near the fluid distribution region.

8. The seat assembly of claim 1, wherein the at least one recirculation passage is located generally below the fluid distribution region.

9. The seat assembly of claim 8, further comprising a scrim located between the at least one recirculation passage and the fluid distribution region.

10. The seat assembly of claim 1, further comprising at least one covering layer along at least one of the first surface and the second surface of the cushion, said at least one covering layer being air permeable.

11. The seat assembly of claim 1, wherein the fluid distribution region comprises at least one spacer material configured to generally distribute fluids entering therein.

12. A climate controlled seat assembly, comprising:
a cushion positioned in at least one of a seat bottom portion and a seat back portion of the seat assembly, said cushion having a first surface configured to contact an occupant and a second surface generally opposite of the first surface;
at least one fluid conduit positioned at least partially within an interior of the cushion;
a fluid module comprising a fluid transfer device and a thermal conditioning device configured to selectively heat, cool or ventilate air, said fluid module;
wherein the fluid module is positioned within a bolster region of the cushion;
wherein an outlet of the fluid module is in fluid communication with the at least one fluid conduit;
at least one fluid distribution member positioned along the first surface of the cushion, said at least one fluid distribution member being configured to receive air from the at least one fluid conduit and to generally distribute said air along the first surface of the cushion; and
at least one recirculation passage configured to return at least a portion of the air that is within or that has exited the at least one fluid distribution member toward an inlet of the fluid module;
wherein said at least one recirculation passage places the at least one fluid module in fluid communication with an area adjacent the first surface of the cushion.

13. The seat assembly of claim 12, wherein the at least one recirculation passage is positioned in the bolster region of the cushion.

14. The seat assembly of claim 12, wherein the at least one recirculation passage originates in or near the at least one fluid distribution member.

15. The seat assembly of claim 12, wherein the at least one recirculation passage is in direct fluid communication with the at least one fluid distribution member.

16. A climate controlled seat, comprising:
a cushion positioned along a seat bottom portion or a seat back portion of the seat assembly, said cushion having a top surface configured to contact an occupant and a bottom surface generally opposite of the first surface;
at least one interior passage extending at least partially within an interior of the cushion, the at least one interior passage terminating at or near at least one fluid channel located along the top surface of the cushion;
wherein the at least one interior passage places the at least one fluid channel in fluid communication with a fluid module in order to selectively transfer air from the fluid module to the at least one fluid channel;
a recess formed along the top surface of the cushion;
wherein the recess at least partially surrounds the at least one fluid channel along the top surface of the cushion;
at least one cover member positioned at least partially within the recess and above the at least one fluid channel, wherein the at least one cover member and the at least one fluid channel define at least one fluid passageway;
a plurality of fluid openings located along the at least one cover member, wherein air exits the at least one fluid passageway through said fluid openings;
wherein the at least one interior passage is offset relative to a horizontal centerline of the cushion; and
wherein the at least one fluid channel is configured to generally hydraulically balance airflow exiting through the plurality of fluid openings.

17. The seat of claim 16, wherein a width of the at least one fluid channel varies along a length of the at least one fluid channel.

18. The seat of claim 16, wherein a depth of the at least one fluid channel varies along a length of the at least one fluid channel.

19. The seat of claim 16, wherein a bottom surface of the at least one fluid channel is sloped relative to the top surface of cushion along at least a portion of a length of the at least one fluid channel.

20. The seat of claim 16, wherein at least two of the plurality of fluid openings vary in size.
